(19) United States
(12) Patent Application Publication
(10) Pub. No.: US 2018/0290901 A1
(43) Pub. Date: Oct. 11, 2018

(54) CAGE PARTICLE DISTRIBUTION SYSTEM FOR WASTEWATER TREATMENT

(71) Applicant: Wesdon-Tienda Environmental Sciences Co. Ltd., Tianjin (CN)

(72) Inventors: Jingxu ZHU, London (CA); Yuanyuan SHAO, London (CA); Keying MA, Tianjin (CN); Lin WANG, Tianjin (CN); George NAKHLA, Woodbridge (CA)

(21) Appl. No.: 15/940,741

(22) Filed: Mar. 29, 2018

(30) Foreign Application Priority Data
Mar. 29, 2017 (CN) 201710196937.4
Mar. 29, 2017 (CN) 201710198063.6

(51) Int. Cl. C02F 1/40; C02F 1/00; C02F 3/34; C02F 3/32

(52) U.S. Cl. CPC C02F 1/40; C02F 1/006; B01D 21/2461; C02F 3/32; C02F 3/341

(57) ABSTRACT

The present invention provides a cage particle distribution system for wastewater treatment comprising contactors. Said contactors include shells and the interior of said shells is a hollow cavity. At least one of the side walls, the upper surface and the lower surface of said shells are equipped with through-holes. Particles are loaded inside said shells and said particles can carry some microorganisms on their surfaces at least. Said cage systems are placed in the water of a wastewater system or a wastewater treatment system and one or multiple said cage systems can be placed. Separate aeration and/or liquid distribution into each individual cage system disperse particles in the system by the gas and/or liquid, which improves the efficiency of wastewater treatment.

### FIELD

The present invention relates to wastewater treatment, and more particularly the present invention relates to a small cage particle distribution system.

### BACKGROUND

With the population growth and economic development, the demand for water increases and so as the discharge of wastewater, leading to the shortage of water resources. Currently, more and more companies start to utilize green technologies to improve water quality by reducing waste production. However, the effects are not very obvious. In order to realize the sustainable development of water resources, it is obliged to treat wastewater and turn it into usable water. Therefore, wastewater treatment technologies are very important. Especially, due to the lack of onsite wastewater treatment technologies in the present, wastewater cannot be treated effectively and in time. The consequence is severer water pollution and gradual deteriorating of water quality.

Wastewater mainly consists of domestic wastewater, industrial wastewater, livestock farm wastewater, agricultural wastewater, etc. The major indicators of wastewater include chemical oxygen demand (COD), biochemical oxygen demand (BOD), ammonia nitrogen, and total phosphorus. Wastewater contains a variety of nutrients facilitating the growth of aquatic plants, pathogenic microorganisms which may cause diseases, and toxic chemical compounds that can be carcinogenic or mutagenic. Therefore, from the perspective of protecting human health and the environment, wastewater must be treated before reuse or discharge. A variety of methods for wastewater treatment can be divided into four categories in terms of mechanisms: physical treatment, chemical treatment, physicochemical treatment, and biological treatment. These methods can be applied together when treating wastewater, wherein the biological treatment is the most economical, effective and widely-used method.

Currently, in most traditional wastewater treatment plants, biological wastewater treatment technology adopts activated sludge methods, such as oxidation ditch activated sludge method, A-B activated sludge method, SBR sequencing batch activated sludge method, feeding activated sludge method, etc. Although the treatment results are able to meet the requirements of “Pollutant Emission Standards of Urban Wastewater Treatment Plants” (GB18918-2002), these methods have low organic load, low microbial concentration, weak ability of bearing impact load, high excess sludge yield, easy occurrence of sludge expansion, leading to low treatment efficiency, high energy consumption, and large amount of excess sludge. Consequently, the apparatus requires a large volume and takes up a lot of space. Thus, a more efficient and energy-saving wastewater treatment technology is needed.

Fluidization technology is a type of novel process for wastewater treatment, featuring with high load and high efficiency. It combines the traditional activated sludge process with the biofilm process and introduces the fluidization technology in chemical engineering. By means of fluidization, microorganisms attach to the solid particles and solid particles are suspended in the wastewater system. Since the relatively large specific surface areas of particles are able to increase the concentration of microorganisms in the system, the efficiency of water treatment will be improved and the entire system will have low sludge yield and high organic load. In the applications of fluidization, the selection of solid particles is the key factor affecting the efficiency of wastewater treatment. However, the distribution of particles is often non-uniform in many particle dispersion systems. This non-uniformity is often caused by the fact that the distribution of the fluid (gas or liquid) used to disperse or suspend particles cannot be guaranteed to be completely uniform when entering the reactors. Alternatively, the fluid is not capable of flowing in parallel, leading to the lack of fluid in certain regions. In addition, the non-uniformity of particle distribution in said particle dispersion systems after industrial scale-up is more obvious and not easily controlled.

### SUMMARY

It is the object of the present invention to provide a cage particle distribution system for wastewater treatment. Separate aeration and/or liquid distribution into each individual cage system disperse particles in the system by the gas or/and liquid, which improves the efficiency of wastewater treatment.

To attain the above objectives, the present invention discloses the following technical solutions:

A cage particle distribution system for wastewater treatment comprising a contactor. Said contactor includes a shell and the interior of said shell has hollow cavities. Said shell is equipped with through-holes. Particles are loaded inside said shell and said particles carry some microorganisms on their surfaces.

The present invention has advantages of easy operation and control, high production efficiency, economical, energy saving, etc. The arrangement of multiple cage particle distribution systems in wastewater systems, including wastewater treatment systems, is convenient for separate aeration and/or liquid distribution in each cage. Therefore, it enables the uniform distribution of particles in each cage system, increasing the concentration of microorganisms and improving the efficiency of wastewater treatment.

The present disclosure provides a cage particle distribution system for wastewater treatment comprising;

a contactor, said contactor including a shell and the interior of said shell having hollow cavities, said shell being equipped with through-holes, particles being loaded inside said shell and said particles having microorganisms on their surfaces, said shell having an aeration and/or liquid distribution system such that the particles are uniformly dispersed by the gas or/and liquid in operation.

The shell has side walls including at least one of the upper surface and lower surface, wherein at least one of the side walls, upper surface, and lower surface is equipped with through-holes, wherein said upper surface and lower surface are fully closed or semi-closed, said lower surface is fully closed or semi-closed and the upper surface and lower surface are not fully closed at the same time, and wherein said side walls, upper surface or lower surface prevent said particles from outflowing.

The shape of said shell is one of cube, rectangle, other polygon, cylinder, and ellipsoid.

The environment of said contactor may be anaerobic, anoxic, or aerobic.

The one or multiple said cage systems are placed into the liquid or gas-liquid two-phase region of a wastewater system or wastewater treatment system.

The aeration system is placed inside or outside said cage systems.

The aeration system is configured so that gas flows upward continuously or intermittently during the operation of the aeration system.

When the aeration system is placed outside said cage, the shell includes a lower surface connecting to the aeration system, and the lower surface is partially or fully open.

The particles may include light particles, heavy particles or mixed particles containing light particles and heavy particles, wherein the density of said light particles is lower than the density of the liquid in the environment where said cage system operates, the density of said light particles is uniform or non-uniform, and the size of said light particles is uniform or non-uniform, wherein the density of said heavy particles is higher than the density of the liquid in the environment where said cage system operates, the density of said heavy particles is uniform or non-uniform, and the size of said heavy particles is uniform or non-uniform, and wherein said particles are dispersed in said liquid.

The one or multiple cage systems are arranged in groups or separately in a wastewater treatment pool, which can be a newly-built and/or existing wastewater treatment system or a component of the wastewater treatment system.

The one or multiple cage particle distribution systems may be arranged in groups or separately in polluted rivers or lakes to treat polluted water.

The cage particle distribution system may be installed in a trailer for the onsite scattered point wastewater treatment.

The multiple cage system is configured so that the exchange between water inside and outside of the cages is promoted by means of water level difference, overflow, partially blocked flow, etc.

The multiple cage system further comprises water pumps or other mechanical water driving devices are used to enable the exchange of internal and external water and wherein said other mechanical water driving devices can employ mechanical water driven methods, such as a windmill or waterwheel, to propel the water flow by the power of wind or water.

The cage particle distribution system configured to be used for chemical or biochemical reactions.

The cage particle distribution system further comprising a plurality of contactors located in an enclosure, said enclosure including a liquid inlet for wastewater to enter said enclosure, and said enclosure including a liquid outlet for treated wastewater to exit the enclosure, said plurality of contactor being arranged in a preselected sequence in said enclosure from said liquid inlet to said liquid outlet, and wherein each contactor includes a preselected selection of light particles and/or heavy particles, and wherein each of said contactors is configured to act as an anaerobic zone, an anoxic zone, and an aerobic zone.

A further understanding of the functional and advantageous aspects of the present disclosure can be realized by reference to the following detailed description and drawings.

### BRIEF DESCRIPTION OF THE DRAWINGS

Embodiments disclosed herein will be more fully understood from the following detailed description thereof taken in connection with the accompanying drawings, which form a part of this application, and in which:

FIG. 1 is the schematic diagram of the cage system in the present invention.

FIG. 2 is the schematic diagram of the employment of the combination of the cage systems in the present invention.

FIG. 3 shows an embodiment of the application of the cage particle distribution systems in wastewater systems or wastewater treatment systems.

FIG. 4 shows another embodiment of the application of the cage particle distribution systems in wastewater systems or wastewater treatment systems.

FIG. 5 shows embodiment of the application of the cage particle distribution systems in polluted rivers or lakes.

FIG. 6 shows an embodiment of the cage particle distribution systems installed in a trailer.

### DETAILED DESCRIPTION

Various embodiments and aspects of the disclosure will be described with reference to details discussed below. The following description and drawings are illustrative of the disclosure and are not to be construed as limiting the disclosure. The drawings are not to scale. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions.

As used herein, the phrase “slightly heavy particles” refers to particles having a density in a range which is higher than the density of the liquid and lower than or equal to 150% of the density of the liquid. Preferably, the density of the slightly heavy particles is between the density of the liquid and lower than or equal to about 120% of the density of the liquid.

To better understand the cage particle distribution system for wastewater treatment, the present invention will be illustrated as follows.

In an embodiment, the present disclosure provides a cage particle distribution system for wastewater treatment comprising a contactor. The contactor includes a shell and the interior of the shell has hollow cavities. The shell is equipped with through-holes. Particles are loaded inside the shell and the particles can carry some microorganisms on their surfaces at least.

In this embodiment, the cage particle distribution system includes at least one cage. The cage can act as the contactor or the contactor lays inside the cage. The contactor is in contact with the wastewater treated by the cage system. Before putting the cage system into use, an external large system, which the cage system acts on, contains the wastewater to be treated. During the process of employing the cage system, through-holes in the shells facilitate the exchange of substances between the cage system and the external large system and microorganisms carried by particles are used to treat wastewater. The relatively large specific surface area of the particles loaded in the shell provides sufficient space for the growth of microorganisms. Hence, it promotes the growth and reproduction of microorganisms on the surface of particles, significantly increases the concentration of microorganisms and the treatment efficiency. Specifically, microorganisms are able to attach to the surface of particles and produce a biofilm. The biofilm may be heterotrophic bacteria or autotrophic bacteria, aiming to facilitate wastewater treatment.

When the cage systems are applied to wastewater treatment, microorganisms grow and shed on the surface of the suspended particle media and renew continuously. Thus, it is easy for them to trigger metabolic degradation reaction with organic pollutants, and/or nitration and denitrification with ammonia and nitrogen, and/or phosphorus release and uptake with phosphorus. The corresponding microorganisms can be selected based on the characteristics of specific wastewater.

Especially, the particles may possess one or more micropores in which microorganisms enrich before or during the process of wastewater treatment. Furthermore, the particles can include micropores and the micropores can include one or more connected cavities at the same time. Microorganisms are enriched inside the cavities in advance and contact with wastewater to perform mass transfer via micropores. The microorganisms can be carried by particles before wastewater treatment or exist in the wastewater and enriched during the treatment.

In another embodiment, the shell includes side walls. These side walls prevent the particles from flowing out of the shell and ensure that particles undertake reactions within the predetermined space for easy manipulation. It is easy to understand that the action of prevention may be only a certain extent as long as a considerable proportion of particles react in the predetermined space.

Furthermore, the shell of the cage distribution system includes at least one of the upper surface and lower surface. The upper surface can be fully closed or semi-closed, the lower surface can be fully closed or semi-closed, and the upper and lower surfaces are not fully closed at the same time. Such an arrangement ensures both the exchange of fluid inside and outside of the shell and the uniform spatial distribution of particles in the system. It is necessary to explain that the shape of the shell in this cage particle distribution system can be various, such as a cube, rectangle, other polygon, cylinder, ellipsoid, etc. In addition to the foregoing regular-shaped shell, the shell may be irregular-shaped. For example, looking down from the top of the shell, the top view of the shell is irregular. Different shell types facilitate the adaptation to different reaction systems.

In another embodiment, the environment of the contactor is anaerobic, and/or anoxic, and/or aerobic. It is conducive for microorganisms to treat different pollutants in different environments.

In another embodiment, the cage systems are placed in the liquid or gas-liquid two-phase fluid of a wastewater system or wastewater treatment system and one or multiple cage systems are placed.

For this embodiment, the cage system contains particles carrying microorganisms. Injecting gas or liquid into the cage system (can also be both gas and liquid), particles in the cage system become generally uniformly dispersed in the system by the separate gas or liquid or the gas-liquid mixture. Meanwhile, microorganisms carried by the particles move around with the motion of particles to treat the surrounding wastewater. It is easy to understand that the gas or liquid is mainly used for the flow of the particles. Thus, the liquid can be untreated wastewater or other liquid besides untreated wastewater, as long as such liquid does not hinder or go against wastewater treatment. If the microbial content is high and the system is easy to control, it would take few efforts to increase the capacity of the system for wastewater treatment. Usually, increasing the number of cage systems is beneficial for the improvement of wastewater treatment efficiency and several cage systems can be connected in cascade or by other means.

In another embodiment, one or multiple the cage systems are placed in a wastewater treatment system that has already been built and in use, such as the anaerobic pool, anoxic pool, or aerobic pool in a biochemical wastewater treatment pool. Since the cage system contains the suspended particles carrying microorganisms, the purpose of enhancing wastewater treatment can be achieved. It is easy to understand that increasing the number of cage systems is conducive to wastewater treatment.

In another embodiment, one or multiple the cage systems are directly placed in a newly-built wastewater treatment system, such as the anaerobic pool, anoxic pool, or aerobic pool in a biochemical wastewater treatment pool, making it an organic component of the wastewater treatment system. Since the cage system contains the suspended particles carrying microorganisms, the purpose of enhancing wastewater treatment can be achieved. It is easy to understand that increasing the number of cage systems is conducive to wastewater treatment.

In the above two embodiments, to ensure that the treated wastewater flows into the cage system effectively, the exchange between water inside and outside the cage system can be promoted by means of water level difference, overflow, partial blocked flow, etc. In another embodiment, one or multiple the cage systems are placed directly in polluted water, such as rivers or lakes. When the polluted water in rivers or lakes flows through the cage systems, it can be effectively treated. It is easy to understand that more cage systems arranged in rivers or lakes is beneficial for wastewater treatment. In order to ensure that most polluted water flows into rather than bypass the cage systems, a proper distribution pattern of cage systems can be used and/or some diversion methods can be added to facilitate the efficient exchange between the cage systems and external water. In other cases, water pumps or other water driving devices can be used to enhance the exchange of interior and exterior water. It should be understood that the water driving devices stated here may include a windmill or watermill without external power and the exchange of interior and exterior water is promoted by the wind power or water flow themselves.

In another embodiment, the cage particle distribution system are installed in a trailer. For some places that cannot access to drainage network, such as scattered towns, residential districts, hotels, tourist areas and mountain areas, the trailer can be used for onsite wastewater treatment. Because the cage particle distribution system has such many advantages as small footprint, high efficiency, low energy consumption, few discharge of sludge and easy controlling, etc., it has a decent prospect to be applied for the treatment of wastewater from scattered points

In another embodiment, each the cage system adopts separate aeration and/or liquid distribution so that the cage systems form independent entirety for easy control. Whether it is separate aeration, or separate liquid distribution, or separate aeration and liquid distribution, the goal is to control the flow of particles.

Moreover, since gas moves upward, the aeration system can be arranged inside or outside the cage system, and aeration inside the cage system is preferable. If gas is arranged outside the cage system, a small amount of particles are allowed to flow out and these effluent particles outside the cage system may have the same technical effects.

In addition, if aeration is outside the cage system, the shell has a lower surface for connecting to the aeration system and the lower surface is open or widely open. This means offer gas a sufficiently large passage to flow through cage systems so as to improve the wastewater treatment capability of the cage system by aeration in the situation that the cage system acts as an independent reactor and interconnected with the external large system.

In another embodiment, the gas flows upward continuously or intermittently. For this embodiment, the gas flows upward either continuously or intermittently, aiming to disperse the particles in the wastewater to be treated in order to treat wastewater more efficiently. It is easy to understand that different gas intake methods, such as continuous or intermittent intake, can be employed depending on the specific needs.

In another embodiment, the particles comprise light particles, heavy particles, or mixed particles containing the light particles and heavy particles. The density of the light particles is higher than 80% of the density of the liquid in the environment where the cage system operates and lower than the liquid density. If the density of the light particles is lower than 80% of the liquid density, the difference between the density of the light particles and the liquid density is too large for a given volume, requiring larger driving force to overcome the buoyancy of light particles and thus higher energy consumption. It is easier for light particles having a density close to the liquid density to suspend in the liquid. The density of the light particles is uniform or non-uniform and the size of the light particles is uniform or non-uniform. When choosing light particles considering the diameter, light particles with a diameter smaller than 10 mm are preferred. The first choice would be light particles with a diameter smaller than 5 mm. The greater the particle diameter, the smaller the specific surface area of the particles, which affects the contact and mass transfer between the gas, liquid and solid.

The density of the heavy particles is higher than the density of the liquid in the environment where the cage system operates and lower than 120% of the liquid density. The density of the heavy particles is uniform or non-uniform and the size of the heavy particles is uniform or non-uniform. If the density of heavy particles is higher than 120% of the liquid density, the difference between the density of the heavy particles and the liquid density is too large for a given volume, requiring larger driving force to overcome the gravity of heavy particles and thus higher energy consumption. It is easier for heavy particles with a density close to the liquid density to suspend in the liquid phase. When choosing heavy particles considering the diameter, heavy particles with a diameter smaller than 10 mm are preferred. The first choice would be heavy particles with a diameter smaller than 5 mm. The greater is the particle diameter, the smaller is the specific surface area of particles. Therefore, the required minimum fluidization velocity would be higher compared to particles with the same density. This condition not only weakens the interphase contact between the gas, liquid and solid but also increases the energy consumption. The particles are dispersed in the liquid. It is easy to understand that the liquid environment can be totally composed of the wastewater to be treated or may include other liquid causing particles to flow as previously described.

For this embodiment, the particles used in the cage systems can be light particles, heavy particles, or mixed particles containing the light particles and heavy particles. The density of the light particles is lower than the density of the liquid. Gas can be fed into the liquid (such as injecting gas from the bottom) to generate the gas-liquid mixture. In this case, the density of the gas-liquid mixture is lower than the density of the liquid and light particles are able to be suspended in the gas-liquid mixture by adjusting the amount of gas intake. The density of the heavy particles is higher than the density of the liquid. Particles can be suspended in the liquid driven by the liquid or gas flow. Alternatively, with the effect of gas and liquid, light particles and heavy particles can be suspended at the same time.

Mixed particles contain light particles and heavy particles. Apart from the advantages of light particles, heavy particles can be brought up from the bottom by relatively low gas velocity or liquid velocity, which facilitates a certain particle distribution in the vertical direction and makes full use of space. Heavy particles can also carry microorganisms, similar to light particles.

Preferably, particles can be more uniformly suspended in the gas-liquid mixture by adjusting the amount of gas intake. Light particles and heavy particles are more evenly suspended by adjusting the flowrate of the liquid and/or gas.

In addition, the size of the particles is changeable and the material and shape of particles are various. The preferred choices are particles with large specific surface area, shape similar to spheres, density close to the liquid, and great liquid contact ability. Preferably, particles should have surfaces that are suitable for the growth of microorganisms.

### Applications of the Present Cage System

The application of the systems disclosed herein will be further described below in relation to wastewater treatment, but it may also be used in other applications, for example, effluent treatment from a host of industrial processes.

The present cage system will now be illustrated using the following non-limiting example.

### Example

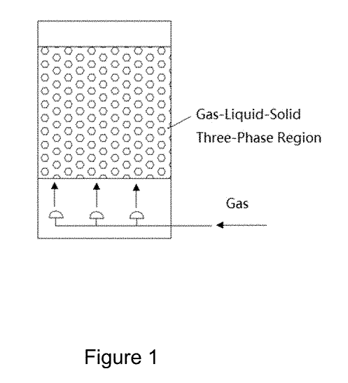

In the embodiment, as shown in FIG. 1, the cage distribution system includes a shell with hollow cavities inside. At least one of the side walls, upper surface or lower surface of the shell is equipped with through-holes, facilitating the exchange between materials inside and outside the system. The shell is loaded with particles, whose relatively large specific surface areas enhance the mass transfer between solids and the fluid.

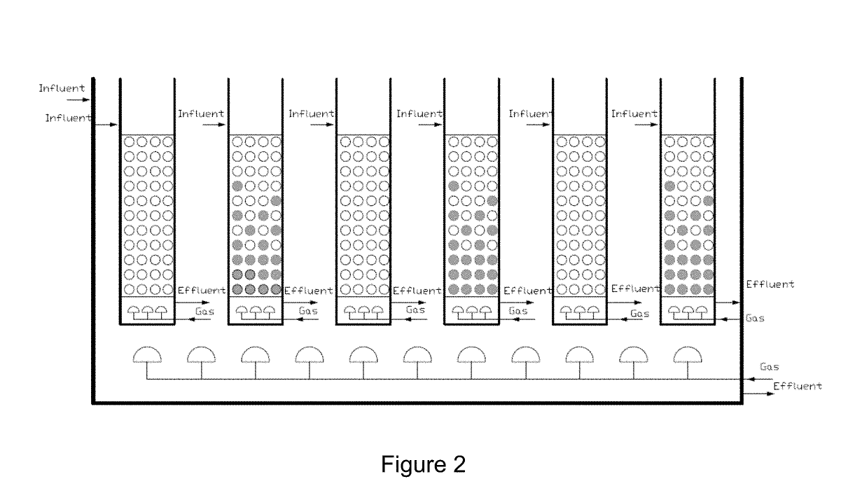

FIG. 2 is the schematic diagram of the employment of the combination of the cage systems disclosed herein. In the wastewater pool with a length×width×height of 12×6×6 m (the size is unlimited and may be other combinations such as 24×12×8, 16×12×6 m, etc.), multiple cage particle distribution systems are installed and each cage is a complete biological wastewater treatment system. The cages have a length×width×height of 2×1×4 m (can also be 1.5×1×6 m, 1×1×6 m, etc.; in short, the size of the cages should be smaller than the size of the large system). Gas distributors are equipped at the bottom of the cages or at the bottom of the large system. If gas distributors are set up at the bottom of the large system, the bottom of the cages can be open or open with a large area to provide a sufficient passage for gas to flow into the systems. The gas supply of both the cage systems and the large system are from the blower. The cages are loaded with solid particles, which can be light particles, heavy particles or mixed particles containing light and heavy particles. Microorganisms carried by solid particles can be used effectively in wastewater treatment. Alternatively, the liquid is fed from the side walls of the cage systems by the pump and particles in the cages are dispersed in the systems by the gas-liquid fluid. Since each cage has separate gas distribution and/or separate liquid distribution, it is easy to control and the production efficiency is high. In order to maintain the suspension of particles in the cages, the fluid velocity in the cages should be higher than the minimum fluidization velocity and lower than the minimum entrainment velocity of particles.

The so-called minimum entrainment velocity of particles refers to the transition velocity from the fluidized bed to the transport bed. The treatment efficiency of the cage systems is more than 5 times larger than that of the large system. Thus, if the cage systems are arranged in an order in the required large system and occupy 50% of the system volume, the productivity of the system can be increased by at least three times.

As shown in FIG. 2, in another embodiment, in the wastewater pool with a length×width×height of 12×6×6 m (can also be other size combinations such as 24×12×8, 16×12×6 m, etc.), six cage particle distribution systems are installed (can also set up small cage systems with other quantities). Each cage is a complete biological wastewater treatment system and has a length×width×height of 2×1×5 m (can also be 1.5×1×6 m, 1×1×6 m, etc.; in short, the size of the cages should be smaller than the size of the large system; it is easy to understand that cage systems are placed inside the large system to treat wastewater).

Gas distributors are equipped at the bottom of the cages and at the bottom of the large system outside the cages, respectively (as the aeration device). The gas supply of both the cage systems and the large system are from the blower. In this embodiment, the large system can also contain aeration devices. According to FIG. 2, the gas intake is conducive for the diffusion of various components in the large system and the cage systems and for wastewater treatment in cage systems.

In FIG. 2, three of the cages are loaded with polyethylene particles with a diameter of 3.5 mm and a density of 950 kg/m³ (can also be other light particles with a diameter smaller than 5 mm and a density between 800 and 1000 kg/m³ that microorganisms can attach to). The other three cages are loaded with polyethylene particles with a diameter of 3.5 mm and a density of 950 kg/m³ (can also be other light particles with a diameter smaller than 5 mm and a density between 800 and 1000 kg/m³) and polystyrene particles with a diameter of 2 mm and a density of 1050 kg/m³ (can also be other heavy particles with a diameter smaller than 5 mm and a density between 1000 and 1200 kg/m³). It is easy to understand that these two types of particles are divided into different categories with the density of water being the boundary. However, whether the water density serves as the boundary in all the applications should depend on the specific wastewater conditions.

Regardless of the density of particles, the total amount of particles added is about 20% of the volume of the cage systems. The outer surface of the added particles carries microorganisms to treat wastewater. Take FIG. 2 as an example. It can be understood that three light particle cage systems and three mixed particle cage systems are placed at intervals. In the figure, the black solid dots represent heavy particles while white solid dots represent light particles.

Among the six cages discussed above, two of them adopt continuous aeration in aerobic environment, two of them adopt intermittent aeration in anoxic environment, and the other two adopt intermittent aeration in anaerobic environment. Preferably, when adopting continuous aeration, the suspension of particles in the cages should be maintained by the gas and liquid. Similarly, when adopting intermittent aeration, the suspension of particles should be maintained by the flow of liquid. Air is used as the gas and the aeration tube can be microporous leather tube. It is easy to understand that the gas and aeration tube may also be other options as long as the wastewater treatment is not affected. For each cage system, wastewater in the large system can be pumped into the cage systems from the top of cages. Treated water is discharged to the large system from the bottom of the cages and then discharged from the bottom of the large system. It is easy to understand that cage systems and the large system can be in cascade or multistage filtering. A variety of combinations are able to meet the requirements of different wastewater treatment standards.

If two sets of cage systems in this embodiment were adopted, i.e., using 12 cage systems for wastewater treatment experiments, the daily capacity was 210 tons. During the operation period, the average COD of the inflow was 250 g/m³, the average NH₄—N was 30 g/m³, the total nitrogen was 36 g/m³, and the total phosphorus was 1.8 g/m³. After 2.0 hours of hydraulic retention time, 91% of COD, 97% of total nitrogen, and 86% of total phosphorus were removed. The effluent met the water standards of “Surface Water Environmental Quality Standards” (GB3838-2002) Class IV in China. Compared to the system not using small cage systems, the efficiency of wastewater treatment were increased over four times.

As shown in FIG. 3, in another embodiment, in order to transform the existing wastewater treatment pool, the cage particle distribution system is introduced into the system to improve the efficiency of wastewater treatment. The wastewater pool to be transformed has a length×width×height of 10×6×5 m and 13 cages are set up in the wastewater pool. Separate aeration and/or liquid distribution in each cage ensures that each cage is a system for biological wastewater treatment. The length×width×height of the cages is 1×1×5 m. These cages are arranged in stagger pattern in the wastewater pool, as shown in FIG. 3. The cages are set up in the form of 3-2-3-2-3 along the direction of wastewater flow, i.e., 3 cages are placed in the first column, 2 cages are arranged in the second column staggered with the first column, and so on. This type of stagger arrangement allows most wastewater to be treated intensively through cages.

Since cages adopt separate aeration and/or liquid distribution, the aeration device may be installed at the bottom of the cages or at the bottom of the large system outside the cages. If installed in the large system, the bottom of the cages is open or widely open. Usually, microporous aeration heads and microporous leather tubes are used as the aeration device, and blowers are used to supply gas for the cage systems and the large system. Air intake is subject to benefit the diffusion of various components in the large system and cage systems and it is conducive to wastewater treatment in the cage systems. Liquid distribution in cages generally employs mechanical wastewater pumps. There are totally 13 cages in this embodiment. Herein, five of them have anaerobic environments, three of them have anoxic environments, and five of them have aerobic environments. Intermittent or continuous aeration can be used respectively depending on different environments.

Each cage is loaded with solid particles. The solid particles can be light particles or/and heavy particles. Microorganisms can be carried on the surface of solid particles or enriched during the process of wastewater treatment. Solid particles are uniformly dispersed in the cage systems by gas and liquid and microorganisms carried by particles can effectively treat wastewater.

Wastewater treatment is realized as follows: wastewater is fed to the wastewater pool from one end and flows to the exit at the other end due to the liquid level difference. During this process, wastewater encounters a series of cages distributed in the wastewater pool. By the overflow or water pump or mechanical water flow, wastewater enters the cage distribution systems and microorganisms carried by particles in the cages treat wastewater effectively. The stagger arrangement of cages in the wastewater pool is able to effectively increase the probability of wastewater entering the cages. It ensures that the wastewater flows into cages with environments having different oxygen demands so that different pollutants can be effectively treated.

In the embodiment, the daily capacity was 150 tons. During the operation period, the average COD of the inflow was 300 g/m³, the average NH₄—N was 32 g/m³, the total nitrogen was 38 g/m³, and the total phosphorus was 1.9 g/m³. After 2.0 hours of hydraulic retention time, 94% of COD, 95% of total nitrogen, and 88% of total phosphorus were removed. The effluent met the water standards of “Surface Water Environmental Quality Standards” (GB3838-2002) Class IV in China. Compared to the system not using small cage systems, the efficiency of wastewater treatment were increased over four times.

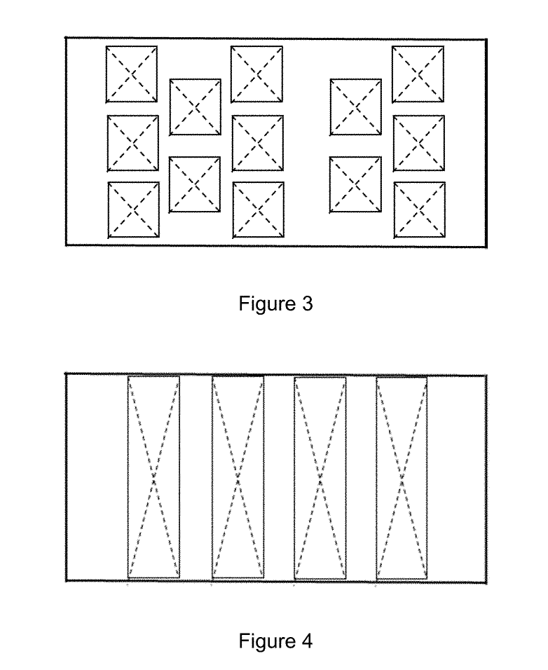

As shown in FIG. 4, in another embodiment, four cage distribution systems are installed in a wastewater pool with a length×width×height of 10×4×6 m. In order for the cage distribution systems to intercept wastewater in the wastewater pool, the cage systems are processed to rectangles with their dimensions in length×width×height being 4×1×6 m. The arrangement of the cage distribution systems in the wastewater pool is demonstrated in FIG. 4. To ensure that each cage is a complete biological wastewater treatment system, each cage should use separate aeration and/or separate liquid distribution.

Since the cages adopt separate aeration and/or liquid distribution, the aeration device may be installed at the bottom of the cages or at the bottom of the large system outside the cages. If installed in the large system, the bottom of the cages is open or widely open. Usually, microporous aeration heads and microporous leather tubes are used as the aeration device and blowers are used to supply gas to the cage systems and the large system. Air intake is subject to benefit the diffusion of various components in the large system and cage systems, and it is conducive to wastewater treatment in the cage systems. Liquid distribution in cages generally employs mechanical water pumps. There are totally four cages in this embodiment. Herein, one of them has anaerobic environment, one of them has anoxic environment, and two of them have aerobic environments. Intermittent or continuous aeration can be used respectively depending on different environments.

Each cage is loaded with solid particles. The solid particles can be light particles or/and heavy particles. Microorganisms can be carried on the surface of is solid particles or enriched during the process of wastewater treatment. Solid particles are uniformly dispersed in the small cage systems by gas and liquid so that microorganisms carried by particles can effectively treat wastewater.

Wastewater treatment is realized as follows: wastewater is fed to the wastewater pool from one end and flows to the exit at the other end due to the liquid level difference. During this process, by the overflow or under the effect of the electric water pump or mechanical water flow, wastewater to be treated enters the cage distribution systems in sequence so that microorganisms carried by particles in the cages treat wastewater effectively. The cage distribution systems are arranged in the wastewater pool in the form of blocked flow, ensuring the wastewater to be treated passes through the four cage systems. Since the four cages have environments with different oxygen demands, different pollutants can be effectively treated in the corresponding environments to improve the efficiency of wastewater treatment.

For the embodiment, the daily capacity was 190 tons. During the operation period, the average COD of the inflow was 310 g/m³, the average NH₄—N was 28 g/m³, the total nitrogen was 35 g/m³, and the total phosphorus was 1.8 g/m³. After 2.0 hours of hydraulic retention time, 96% of COD, 93% of total nitrogen, and 86% of total phosphorus were removed. The effluent met the water standards of “Surface Water Environmental Quality Standards” (GB3838-2002) Class IV in China. Compared to the system not using small cage systems, the efficiency of wastewater treatment were increased over four times.

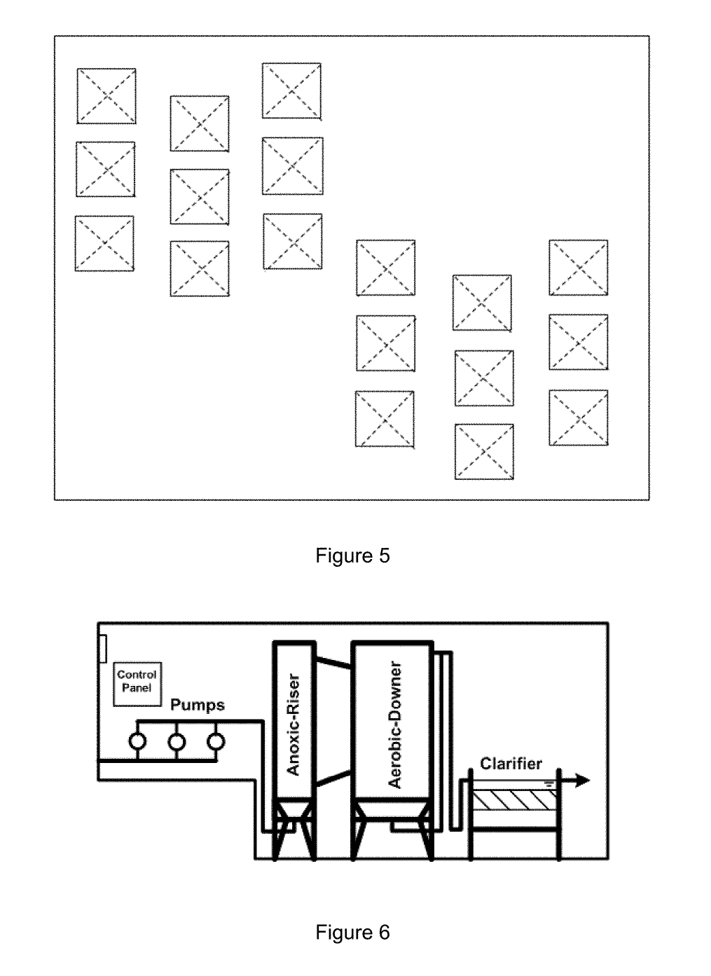

As shown in FIG. 5, in another embodiment, the cage particle distribution systems are introduced into the wastewater system to effectively treat polluted water in rivers or lakes. Multiple cages are set up in relatively narrow water areas along the river direction and each cage adopts separate aeration and/or separate liquid distribution to ensure each cage is a biological wastewater treatment system. The length×width×height of cages is 1×1×3 m. These cages are arranged in the river or lake in a clustered but symmetrical staggered form, shown in FIG. 5. This arrangement allows most wastewater to be intensively treated through the cages and can diminish the impact on the apparatus by the rapid flow.

The cages adopt separate aeration and/or liquid distribution. Usually, microporous aeration heads and microporous leather tubes are used as the aeration device and blowers are used to supply gas for the cage systems and the large system. Air intake is subject to benefit the diffusion of various components in the large system and cage systems and it is conducive to wastewater treatment in the cage systems. Liquid distribution in cages generally employs mechanical wastewater pumps. There are a total of eighteen (18) cages in this embodiment. Herein, six of them have anaerobic environments, six of them have anoxic environments, and six of them have aerobic environments. Intermittent or continuous aeration can be used respectively depending on different environments.

Each cage is loaded with solid particles. The solid particles can be light particles or/and heavy particles. Microorganisms can be carried on the surface of solid particles or enriched during the process of wastewater treatment. Solid particles are uniformly dispersed in the small cage systems by gas and liquid so that microorganisms carried by particles can effectively treat wastewater.

Wastewater treatment is realized as follows: wastewater in rivers or lakes flows in the direction of the river. During this process, wastewater encounters a series of cages distributed in the river or lake. By the overflow or electric water pump or mechanical water flow, wastewater enters the cage distribution systems and microorganisms carried by particles in the cages treat wastewater effectively. The stagger arrangement of cages in the river or lake is able to effectively increase the probability of wastewater entering the cages. It ensures that the wastewater flows into cages with environments having different oxygen demands so that different pollutants can be effectively treated.

In this embodiment, the daily capacity was 300 tons. During the operation period, the average COD of the inflow was 180 g/m³, the average NH₄—N was 36 g/m³, the total nitrogen was 45 g/m³, and the total phosphorus was 1.9 g/m³. After 1.5 hours of hydraulic retention time, 96% of COD, 94% of total nitrogen, and 89% of total phosphorus were removed. The effluent met the water standards of “Surface Water Environmental Quality Standards” (GB3838-2002) Class IV in China. Compared to the system not using small cage systems, the efficiency of wastewater treatment were increased over four times.

As shown in FIG. 6, in another embodiment, two cages with the same height of 3 m and the diameters of 0.6 m and 1.2 m, respectively, are installed in a trailer with the dimension of L×W×H=8.6×2.5×4 m. The cages are equipped with separate aeration and/or liquid distribution. Usually, microporous aeration heads and microporous leather tubes are used as the aeration device, while blowers are used to supply gas for the cage systems. Liquid distribution in cages generally are employed with mechanical wastewater pumps.

Each cage is loaded with solid particles. The solid particles can be light particles or/and heavy particles. Microorganisms can be carried on the surface of solid particles or enriched during the process of wastewater treatment. Solid particles are uniformly dispersed in the small cage systems by gas and liquid so that microorganisms carried by particles can effectively treat wastewater.

For this embodiment, the daily capacity was 50 tons. During the operation period, the average COD of the inflow was 280 g/m³, the average NH₄—N was 37 g/m³, the total nitrogen was 43 g/m³, and the total phosphorus was 1.8 g/m³. After 2.1 hours of hydraulic retention time, 97% of COD, 93% of total nitrogen, and 88% of total phosphorus were removed. The effluent met the water standards of “Surface Water Environmental Quality Standards” (GB3838-2002) Class IV in China. Compared to the system not using small cage systems, the efficiency of wastewater treatment were increased over four times.

In another embodiment, the cage systems are applied in other multiphase flow systems. Multiple cages may be equipped in different axial or/and radial positions in the system and each cage is operated independently. Since the cages are easy to control and adjust and have a high efficiency of mass transfer and heat transfer, they are also subordinate to the large system. Overall, the setup of cages can significantly increase the efficiency of interphase contact in the large system. Some specific applications are the extraction of ginkgo biloba flavonoids from ginkgo biloba, the separation and extraction of legume protein, etc.

In another embodiment, the cage systems are applied in reactors, such as chemical reaction systems. Multiple cages may be equipped in different axial or/and radial positions in the system so that each cage becomes a complete reaction system. Since the cages are easy to control and have a high efficiency of mass transfer and heat transfer, such setup reaches the goal of improving the local reaction efficiency or/and the reaction intensity.

In addition, the cages are subordinate to the large reaction system. Overall, the setup of cages can effectively disperse solid particles and can be adjusted immediately and efficiently according to the changes of working conditions (such as the generation of side reactions and the increase of products), so as to improve the reaction efficiency of the reactors. Specific applications include coal liquefaction, heavy oil reforming, catalytic hydrogenation, nitrobenzene catalytic hydrogenation to produce aniline, etc.

While the above descriptions are related to wastewater systems or wastewater treatment systems, the cage particle distribution system can also be used for many other purposes, such as chemical or biological reactions, fluid-particle contact. For example, catalytic particles contained in a cage that is immersed into a gas-liquid reaction system may promote the gas-liquid reaction, given the large surface areas available from the catalytic particles. For another example, for a gas phase catalytic reaction in a fluidized bed, the solid particles may be placed inside multiple cases instead of the large container, so that the catalytic particles can be removed and replaced easily.

The foregoing description of the preferred embodiments of the present disclosure have been presented to illustrate the principles of the invention and not to limit the invention to the particular embodiments illustrated. Each embodiment is described in a progressive manner. The same or similar sections of each embodiment can be referred to each other and each embodiment emphasizes on the differences from other embodiments. Any minor modifications made to the above embodiments according to the technical substance of the present invention is equivalent to substitution and improvement and shall be included within the scope of the present invention as defined by the appended claims.

Therefore, what is claimed is:

1. A cage particle distribution system for wastewater treatment comprising;
a contactor, said contactor including a shell and the interior of said shell having hollow cavities, said shell being equipped with through-holes, particles being loaded inside said shell and said particles having microorganisms on their surfaces, said shell having an aeration and/or liquid distribution system such that the particles are uniformly dispersed by the gas or/and liquid in operation.

2. The cage particle distribution system for wastewater treatment according to claim 1 wherein said shell has side walls including at least one of the upper surface and lower surface, wherein at least one of the side walls, upper surface, and lower surface is equipped with through-holes, wherein said upper surface and lower surface are fully closed or semi-closed, said lower surface is fully closed or semi-closed and the upper surface and lower surface are not fully closed at the same time, and wherein said side walls, upper surface or lower surface prevent said particles from outflowing.

3. The cage particle distribution system for wastewater treatment according to claim 1 wherein the shape of said shell is one of cube, rectangle, other polygon, cylinder, and ellipsoid.

4. The cage particle distribution system for wastewater treatment according to claim 1 wherein the environment of said contactor may be anaerobic, anoxic, or aerobic.

5. The cage particle distribution system for wastewater treatment according to claim 1 wherein one or multiple said cage systems are placed into the liquid or gas-liquid two-phase region of a wastewater system or wastewater treatment system.

6. The multiple cage system for wastewater treatment according to claim 7 wherein the aeration system is placed inside or outside said cage systems.

7. The multiple cage system for wastewater treatment according to claim 1 wherein the gas flows upward continuously or intermittently during the operation of the aeration system.

8. The multiple cage system for wastewater treatment according to claim 6 wherein when said aeration system is placed outside said cage, said shell has a lower surface connecting to said aeration system, and said lower surface is open or widely open.

9. The cage particle distribution system for wastewater treatment according to claim 1 wherein said particles include light particles, heavy particles or mixed particles containing light particles and heavy particles, wherein the density of said light particles is lower than the density of the liquid in the environment where said cage system operates, the density of said light particles is uniform or non-uniform, and the size of said light particles is uniform or non-uniform, wherein the density of said heavy particles is higher than the density of the liquid in the environment where said cage system operates, the density of said heavy particles is uniform or non-uniform, and the size of said heavy particles is uniform or non-uniform, and wherein said particles are dispersed in said liquid.

10. The multiple cage system for wastewater treatment according to claim 5 wherein one or multiple cage systems are arranged intensively or separately in the wastewater treatment pool, which can be a newly-built and/or existing wastewater treatment system or a component of the wastewater treatment system.

11. The multiple cage system for wastewater treatment according to claim 5 wherein one or multiple cage particle distribution systems are arranged intensively or separately in polluted rivers or lakes to treat polluted water.

12. The multiple cage system for wastewater treatment according to claim 4 wherein said cage particle distribution systems are installed in a trailer for the onsite scattered point wastewater treatment.

13. The multiple cage system for wastewater treatment according to claim 12 wherein the exchange between water inside and outside of said cages is promoted by means of water level difference, overflow, partially blocked flow, etc.

14. The multiple cage system for wastewater treatment according to claim 11 wherein water pumps or other mechanical water driving devices are used to enable the exchange of internal and external water and wherein said other mechanical water driving devices can employ mechanical water driven methods, such as a windmill or waterwheel, to propel the water flow by the power of wind or water.

15. The cage particle distribution system for wastewater treatment according to claim 1 wherein the same system can be used for chemical or biochemical reactions.

16. The cage particle distribution system for wastewater treatment according to claim 1 further comprising a plurality of contactors located in an enclosure, said enclosure including a liquid inlet for wastewater to enter said enclosure, and said enclosure including a liquid outlet for treated wastewater to exit the enclosure, said plurality of contactor being arranged in a preselected sequence in said enclosure from said liquid inlet to said liquid outlet, and wherein each contactor includes a preselected selection of light particles and/or heavy particles, and wherein each of said contactors is configured to act as an anaerobic zone, an anoxic zone, and an aerobic zone.
